(19) United States
(12) Patent Application Publication
(10) Pub. No.: US 2010/0243402 A1
(43) Pub. Date: Sep. 30, 2010

(54) DEVICE FOR ACTUATING A DUAL CLUTCH TRANSMISSION

(75) Inventor: Pascal MOMAL, Velizy Villacoublay (FR)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/729,949

(22) Filed: Mar. 23, 2010

(30) Foreign Application Priority Data
Mar. 24, 2009 (GB) 0904987.5

(51) Int. Cl. F16D 25/10

(52) U.S. Cl. 192/85.63

(57) ABSTRACT

A device is provided for actuating a dual clutch transmission (DCT). In order to provide a device for actuating a dual clutch transmission for controlling a double clutch transmission with 5 synchronizer actuators and 2 input clutch actuators, the device includes, but is not limited to two branches, one branch comprising four flow regulators and one pressure regulator and the second branch comprising three flow regulators and one pressure regulator. The hydraulic system controls two clutch actuator pressures and five gear actuator positions. In this context, the flow regulators are used to control the rod position of a dual effect hoist and the pressure regulators control the effort available on the rod of a single effect hoist through a calibrated orifice.

### CROSS-REFERENCE TO RELATED APPLICATION

This application claims priority to British Patent Application No. GB 0904987.5, filed Mar. 24, 2009, which is incorporated herein by reference in its entirety.

### TECHNICAL FIELD

The invention concerns a device for actuating a dual clutch transmission (DCT).

### BACKGROUND

A device and a process for actuating a clutch of a vehicle is known from document DE 10 2005 006 431 A1. This device comprises at least one actuator for actuating the clutch and a reservoir for a hydraulic fluid. At least one pressure regulator and at least one flow regulator are placed in series before the actuator. Furthermore the device comprises a security valve.

At least one object of the present invention is to provide a device for actuating a dual clutch transmission for controlling a double clutch transmission with 5 gear/synchronizer actuators and 2 input clutch actuators. In addition, other objects, desirable features, and characteristics will become apparent from the subsequent detailed description of the invention and the appended claims, taken in conjunction with the accompanying drawings and this background.

### SUMMARY

The at least one object, other objects, desirable features, and characteristics, are achieved in that the device comprises two fluid communications or branches for a hydraulic fluid such as tubes, pipings or the same. One fluid communication comprises three flow regulators and one pressure regulator and the second fluid communication comprises two flow regulators and one pressure regulator. The two pressure regulators serve to control the hydraulic pressure in the two clutch actuators and the five flow regulators serve to control the position of the five gear actuators

The device according to an embodiment of the invention controls two clutch actuator pressures and five gear actuator positions. In this context, the flow regulators are used to control the rod position of a dual effect hoist and the pressure regulators control the effort available on the rod of a single effect hoist through a calibrated orifice.

According to a preferred embodiment of the invention, the flow regulators are electro-hydraulic flow regulators.

It is also within the scope of the invention that the pressure regulators are electro-hydraulic pressure regulators.

According to an embodiment of the present invention, the exhausts of the flow regulators and of the pressure regulators are connected together by means of connection channels.

In this context, it is preferable that a pressure limiter is provided for limiting the pressure in the connection channels.

The connection channels connect the exhausts of the flow regulators and of the pressure regulators to the pressure limiter which opens when a previously fixed pressure level is attained.

According to an embodiment of the present invention, each branch comprises a safety checkball.

### BRIEF DESCRIPTION OF THE DRAWINGS

The present invention will hereinafter be described in conjunction with the following drawing figure, t, where

FIG. 1 shows a schematic view of the hydraulic system according to an embodiment of the invention.

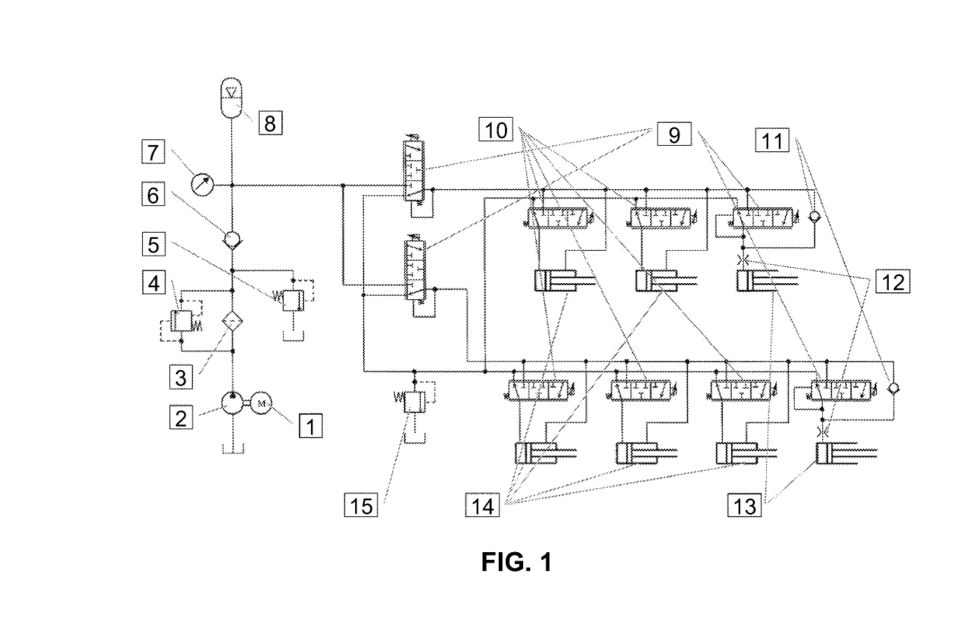

### DETAILED DESCRIPTION

The following detailed description is merely exemplary in nature and is not intended to limit application and uses. Furthermore, there is no intention to be bound by any theory presented in the preceding background or summary or the following detailed description.

An electric engine 1 drives a hydraulic pump 2. Hydraulic liquid is pumped by the hydraulic pump 2 from a reserve. The pump outflow goes through a filter 3 or a by-pass 4 and through a check-ball 6 into an accumulator 8.

The hydraulic pump 2 is protected by a pressure limiter 5. A pressure sensor 7 measures the pressure in the accumulator 8 in order to stop the engine 1 when the pressure in the accumulator 8 exceeds a previously defined level and in order to restart the engine 1 when the pressure in the accumulator 8 is below another previously defined level.

The accumulator 8 feeds two pressure regulators 9 in order to regulate two distinct circuits with different circuit pressures in each one. Each circuit contains two (first circuit, above in the schematic view) or three (second circuit, below in the schematic view) flow regulators 10. The purpose of these flow regulators 10 is to control the position of a gear actuator 14.

Furthermore, each circuit contains one pressure regulator 9. The function of these pressure regulators 9 is to control the pressure in a clutch actuator 13 through a restriction 12.

A safety checkball 11 protects the clutch in case of a failure of the pressure regulator 9.

All exhausts of the pressure regulators 9 and of the flow regulators 10 are connected via connection channels to a pressure limiter 15 which opens if a previously fixed pressure level is reached within the circuit.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for hydraulically actuating a dual clutch transmission that includes at least five gear actuators and at least two clutch actuators, the device comprising:
a first fluid communication comprising at least three flow regulators and at least a first pressure regulator; and
a second fluid communication comprising at least two flow regulators and at least a second pressure regulator,
wherein the first pressure regulator and the second pressure regulator are adapted to control a hydraulic pressure in the at least two clutch actuators and the at least three flow regulators and the at least two flow regulators are adapted to control a position of the at least five gear actuators.

2. The device according to claim 1, wherein the at least three flow regulators and the at least two flow regulators are electro-hydraulic flow regulators.

3. The device of claim 1, wherein the first pressure regulator and the second pressure regulator are electro-hydraulic pressure regulators.

4. The device of claim 1, wherein exhaust of the at least three flow regulators and the at least two flow regulators are connected with connection channels.

5. The device of claim 4, further comprising a pressure limiter that is adapted to limit the hydraulic pressure in the connection channels.

6. The device according to claim 1, further comprising a safety checkball for the first fluid communication and the second fluid communication.
